(19) United States
(12) Patent Application Publication
(10) Pub. No.: US 2026/0256066 A1
(43) Pub. Date: Sep. 3, 2026

(54) METHOD AND SYSTEM FOR AUTOMATED INDOOR VERTICAL CULTIVATION OF PLANTS

(71) Applicant: SPROUT AI, S.A., Panama Pacifico (PA)

(72) Inventor: Chris BOLTON, Panama Pacifico (PA)

(21) Appl. No.: 18/718,231

(22) PCT Filed: Dec. 12, 2022
(86) PCT No.: PCT/IB2022/062076

§ 371 Date: Jun. 10, 2024

(30) Foreign Application Priority Data
Oct. 12, 2021 (GB) 2117915.5
Oct. 12, 2021 (SG) 10202113746Y

(51) Int. Cl. A01G 31/02; A01G 31/00

(52) U.S. Cl. CPC A01G 31/025; A01G 31/011

(57) ABSTRACT

Disclosed is a method for automated indoor vertical cultivation of plants. The method comprises supplying seeds, plant cuttings, or plant tissue culture, to an indoor vertical cultivation system, comprising at least one cultivation rack configured to house multiple habitats configured to grow plants under optimal growth conditions unique to plant therein. Moreover, the method comprises operating a software module for measuring, controlling and monitoring, based on data associated with the plant obtained from database, optimal growth conditions in multiple habitats that is capable of continual learning and improvement. The software module is configured to operate a water supply arrangement and an air sanitization arrangement, operatively coupled to each of the multiple habitats that are on different harvest schedule, to provide a water supply and clean air, respectively, thereto. Disclosed also is an indoor vertical cultivation system for cultivation of plants.

### TECHNICAL FIELD

The present disclosure relates generally to cultivation of plants; and more specifically, to methods for automated indoor vertical cultivation of plants. The present disclosure also relates to systems for automated indoor vertical cultivation of plants.

### BACKGROUND

Recently, vertical farming has emerged as an alternative way for providing more plant-based food, in comparatively less time compared to the traditional farming, to feed a growing global population amid a decrease in arable land. A subset of vertical farming enables growing crops without soil (i.e. by using nutrients) in vertically stacked layers under controlled environmental conditions to achieve optimized plant growth, yield, and quality. Typically, the vertical farming may include techniques such as hydroponics, aquaponics, aeroponics, and so forth. It will be appreciated that each of the said techniques significantly differ from each other. For example, hydroponics and aquaponics are associated with inefficient water usage therein, while aeroponics requires a very small amount of water, having nutrients mixed therewith, to be provided to the roots of the plant. It will be appreciated that the said techniques may employ various systems that are complex, power-consuming, operationally challenging, involving higher labour costs and so on.

Moreover, a sub-technology of the aeroponics is fogponics. Fogponics typically uses a suspension of nutrient-enriched water, supplied in the form of mist, to deliver nutrients and oxygen to the roots for the cultivation of plants having a high yield and quality. In this regard, the existing fogponics systems typically employ an ultrasonic fog producer, that emits a dense vapour that appears similar to fog. However, such existing fogponics systems fail to address the problem due to the heat produced, such as up to 40° C., by such ultrasonic fog producers that may kill the plants. Furthermore, the existing fogponics systems provide overall temperature control for the entire system that may not be appropriate for different parts of the plant. Additionally, the existing fogponics systems may require constant supervision and human intervention in order to maintain pH, humidity, and other growth conditions within the system, thus impacting the quality of the plants. Moreover, the ultrasonic fog producer increases the cost of operation of the existing fogponics systems due to high power consumption thereby.

Therefore, in light of the foregoing discussion, there exists a need to overcome the aforementioned drawbacks associated with conventional vertical indoor cultivation of plants.

### SUMMARY

The present disclosure seeks to provide a method for automated indoor vertical cultivation of plants. The present disclosure also seeks to provide a system for automated indoor vertical cultivation of plants. The present disclosure seeks to provide a solution to the existing problem of providing optimal growth conditions for the indoor vertical cultivation of plants. An aim of the present disclosure is to provide a solution that overcomes at least partially the problems encountered in prior art, and provides an efficient, reliable, eco-friendly, user-friendly, and cost-efficient system.

In one aspect, an embodiment of the present disclosure provides a method for automated indoor vertical cultivation of plants, the method comprising:
supplying seeds, plant cuttings, or plant tissue culture, to an indoor vertical cultivation system for cultivation of plants, the indoor vertical cultivation system comprising at least one cultivation rack configured to house multiple habitats, wherein each of the multiple habitats is configured to grow the plants under optimal growth conditions unique to the plant therein; and
operating a software module, associated with the indoor vertical cultivation system, for measuring, controlling and monitoring the optimal growth conditions in each of the multiple habitats that is capable of continual learning and improvement,
wherein the software module is configured to operate a water supply arrangement and an air sanitization arrangement, operatively coupled to each of the multiple habitats, to provide a water supply and clean air, respectively, thereto.

In another aspect, an embodiment of the present disclosure provides an indoor vertical cultivation system for cultivation of plants, the indoor vertical cultivation system comprising:
at least one cultivation rack configured to house multiple habitats, wherein each of the multiple habitats is configured to grow the plants, from a supply of seeds, plant cuttings, or plant tissue culture, under optimal growth conditions unique to the plant therein; and
a software module, associated with the indoor vertical cultivation system, for measuring, controlling and monitoring the optimal growth conditions in each of the multiple habitats that is capable of continual learning and improvement,
wherein the software module is configured to operate a water supply arrangement and an air sanitization arrangement, operatively coupled to each of the multiple habitats, to provide a water supply and clean air, respectively, thereto.

In yet another aspect, an embodiment of the present disclosure provides a computer program product comprising a non-transitory computer-readable storage medium having computer-readable instructions stored thereon, the computer-readable instructions being executable by a computerized device comprising processing hardware to execute the aforementioned method.

In still another aspect, an embodiment of the present disclosure provides a computer program product that employs artificial intelligence to continually optimize the aforementioned method to reduce water, power and cycle time while increasing yield weight, improving crispness, flavour and/or shelf life through the measurement, collection, management, analysis, and correlation of the data collected during the run of the aforementioned method.

Embodiments of the present disclosure substantially eliminate or at least partially address the aforementioned problems in the prior art, and provide a method for automated indoor vertical cultivation of plants. The disclosed indoor vertical cultivation system is designed to cultivate multiple crops at a time by efficiently utilizing the space therein, thereby making it an efficient, economical, practical, repeatable (or reusable), scalable, safe and secure cultivation system for cultivating plants. In this regard, the indoor vertical cultivation system comprises self-contained multiple habitats, each of which includes a power converter, a dehumidification arrangement, a water supply arrangement, a root chamber environment modulation arrangement, a light supply arrangement, an air conditioning arrangement, and an air sanitization arrangement to provide optimized growth conditions for plants having different growth requirements and harvest schedules. Moreover, the indoor vertical cultivation system eliminates the need for frequent human intervention. Furthermore, the indoor vertical cultivation system eliminates the need for additional processes, such as sterilization and cleansing of plants, thus providing purely organic plants. Furthermore, the indoor vertical cultivation system employs cultivation racks to manage multiple crops, thereby making the system space-efficient, cost-efficient, and preventing potential contamination of plants. Advantageously, the indoor vertical cultivation system uses a software module for measuring, controlling, and monitoring the optimal growth conditions in each of the multiple habitats suitable for the plant thereon, based on the data associated with the plant stored in a database operatively coupled with the software module. Moreover, the software module is compliant with food-grade and EU GMP standards-compliant indoor vertical cultivation system to cultivate purely organic plants.

Additional aspects, advantages, features, and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those skilled in the art will understand that the drawings are not to scale. Wherever possible, like elements have been indicated by identical numbers.

Embodiments of the present disclosure will now be described, by way of example only, with reference to the following diagrams wherein:

FIG. 1 is a flowchart of steps of a method for automated indoor vertical cultivation of plants, in accordance with an embodiment of the present disclosure;

FIGS. 2A and 2B, is a schematic illustration of the controller connectivity without and with failover, respectively, in accordance with an embodiment of the present disclosure;

FIG. 3, is a top view of a floor plan of the cultivation racks of the indoor vertical cultivation system, in accordance with an embodiment of the present disclosure;

FIGS. 4A and 4B, are schematic illustrations of a failover diagram of the indoor vertical cultivation system, in accordance with various embodiments of the present disclosure;

FIG. 5, is a block diagram of an indoor vertical cultivation system for cultivation of plants with various arrangements associated therewith, in accordance with an embodiment of the present disclosure; and

FIGS. 6A and 6B, are schematic illustrations of exemplary implementation of network connectivity to the indoor vertical cultivation system, in accordance with various embodiments of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

In one aspect, an embodiment of the present disclosure provides a method for automated indoor vertical cultivation of plants, the method comprising:
supplying seeds, plant cuttings, or plant tissue culture, to an indoor vertical cultivation system for cultivation of plants, the indoor vertical cultivation system comprising at least one cultivation rack configured to house multiple habitats, wherein each of the multiple habitats is configured to grow the plants under optimal growth conditions unique to the plant therein; and
operating a software module, associated with the indoor vertical cultivation system, for measuring, controlling and monitoring the optimal growth conditions in each of the multiple habitats that is capable of continual learning and improvement,
wherein the software module is configured to operate a water supply arrangement and an air sanitization arrangement, operatively coupled to each of the multiple habitats, to provide a water supply and clean air, respectively, thereto.

In another aspect, an embodiment of the present disclosure provides an indoor vertical cultivation system for cultivation of plants, the indoor vertical cultivation system comprising:
at least one cultivation rack configured to house multiple habitats, wherein each of the multiple habitats is configured to grow the plants, from a supply of seeds, plant cuttings, or plant tissue culture, under optimal growth conditions unique to the plant therein; and
a software module, associated with the indoor vertical cultivation system, for measuring, controlling and monitoring the optimal growth conditions in each of the multiple habitats that is capable of continual learning and improvement,
wherein the software module is configured to operate a water supply arrangement and an air sanitization arrangement, operatively coupled to each of the multiple habitats, to provide a water supply and clean air, respectively, thereto.

In yet another aspect, an embodiment of the present disclosure provides a computer program product comprising a non-transitory computer-readable storage medium having computer-readable instructions stored thereon, the computer-readable instructions being executable by a computerized device comprising processing hardware to execute the aforementioned method.

In still another aspect, an embodiment of the present disclosure provides a computer program product that employs artificial intelligence to continually optimize the aforementioned method to reduce water, power and cycle time while increasing yield weight, improving crispness, flavour and/or shelf life through the measurement, collection, management, analysis, and correlation of the data collected during the run of the aforementioned method.

The present disclosure provides the aforementioned method and the aforementioned system for automated indoor vertical cultivation of plants. The aforementioned method employs the indoor vertical cultivation system having self-contained, hermetically sealed multiple habitats, each of which is automated using a software module for measuring, controlling and monitoring the optimal growth conditions specific for cultivating plants therein. Moreover, the multiple habitats may be set on a different harvest schedule to enable the growth of different types of plants therein at the same time by eliminating the risks of seasonality, travel distance, blight, and disruption due to pandemic. In this regard, the software module operates various arrangements, such as a water supply arrangement, a root chamber environment modulation arrangement, a light supply arrangement, an air conditioning arrangement, and an air sanitization arrangement, operatively coupled to each of the multiple habitats, to provide optimal growth conditions to cultivate the plant therein. Moreover, the air sanitization arrangement employs a series of filters and an ultraviolet germicidal irradiation to clean the air by removing potential contamination agents. Furthermore, the method for indoor vertical cultivation of plants uses fogponics technique to save water consumption, thereby making the method environment friendly and energy-efficient. In this regard, the system employs a dehumidification arrangement that recirculates water in the system for growth of plants.

Throughout the present disclosure, the term “indoor vertical cultivation” as used herein refers to an indoor, generally soilless, farming for cultivating plants in vertically stacked layers under optimal growth conditions. Typically, indoor vertical cultivation of plants may employ hydroponics, aquaponics, aeroponics, fogponics, and so forth. Notably, indoor vertical cultivation of plants reduces labour cost (compared to labour effort on hectares of land) and increases product quality and yield, thereby providing a better return on investment (ROI). Moreover, indoor vertical cultivation of plants such as green-leafy vegetables, bonsai, fruits, vegetables, mushrooms, fungi, microgreens, medicinal herbs, and the like, have been successful in the past few years.

Pursuant to the embodiments of the present disclosure, the method comprises supplying seeds, plant cuttings, or plant tissue culture to the indoor vertical cultivation system comprising at least one cultivation rack configured to house multiple habitats, wherein each of the multiple habitats is configured to grow the plants under optimal growth conditions unique to the plant therein. It will be appreciated that the indoor vertical cultivation of plants is achieved in a dedicated system referred to as the indoor vertical cultivation system. The indoor vertical cultivation system is an energy-intensive, self-contained, hermetically-sealed chamber having integrated therewith multiple arrangements or technologies that operate together to provide plants having good quality and yield. Optionally, the indoor vertical cultivation system may be an aeroponic system or a fogponics system. While the aeroponics system enables the soilless cultivation of plants in an air or mist environment using an aggregate medium/growth media, a subset of aeroponics system, the fogponics system is preferred as it enables the use of technologies (such as ultrasonic, compressed air, or heating elements) to form a suspension of much smaller particles of water vapor to deliver nutrients and oxygen to plant roots. Alternatively, optionally, the indoor vertical cultivation system could be a hydroponic system that involves soilless cultivation of plants using organic fluid mineral nutrient solutions in an aqueous solvent.

The term “cultivation rack” as used herein refers to a solid framework or a stand-like structure to place and hold objects, namely, plants or plants material such as seeds, plant cuttings, plant tissue culture, and so forth, therein. The at least one cultivation rack may be fabricated using a fabrication material selected from at least one of: a metal, an alloy of metal, a wood, a plastic, or a combination thereof. Notably, the cultivation rack is fabricated to utilize space to grow more plants in less horizontal area. Additionally, the separate multiple habitats mitigate external and cross-contamination risk of the plants.

Optionally, at least one cultivation rack is a movable rack. Beneficially, the movable rack eliminates the need for static isle space, reduces setting-up time, and thereby makes the system cost-effective and space-efficient and labour-efficient. Optionally, the at least one cultivation rack may be customized based on the required size, capacity, strength and endurance to environmental and mechanical forces acting thereupon. Optionally, at least one cultivation rack may be 1 to 5 levels high, with each level housing multiple habitats. The term “multiple habitats” as used herein refers to a self-contained, scalable and modular arrangement that provides optimal growth conditions, including, but not limited to, heating, ventilating and air conditioning, nutrients, lighting, humidity, for the indoor vertical cultivation of the plants each of which may be grown in different optimal growth conditions. Moreover, each of the multiple habitats is designed to have a separate arrangement for providing optimal growth conditions, and thus be on a different harvest schedule, suitable for specific plants thereon.

The term “optimal growth conditions” as used herein refers to environmental parameters that are required to provide optimal growth conditions that enable efficient cultivation of the plants. Optionally, the optimal growth conditions are selected from at least one of: temperature, humidity, air quality, light, nutrients, water circulation, water vapour size, pH, biological oxygen demand, total dissolved solids, carbon dioxide level, and electrical conductivity. Moreover, the optimal growth conditions may be relative concentrations of nitrogen gas, methane gas, sulphur dioxide gas, and carbon monoxide gas besides the aforementioned parameters. Typically, the electrical conductivity (EC) is an index of salt concentration that indicates electrolyte concentration of the nutrient solution in each of the multiple habitats. Optionally, the EC of the nutrient solution may be related to the number of ions available to plants in the root chamber environment. Optionally, the optimal EC is crop-specific and may depend on environmental conditions and other growth conditions inside the multiple habitats. Optionally, if the EC measurement stays the same it shows that the plant is using as much water as it's nutrient and is balanced. Optionally, if the EC measurement goes down it indicates that the plant is using up more nutrients than water. Optionally, if the EC measurement goes up it indicates that the plant is using more water than a nutrient.

It will be appreciated that each plant has a unique genetic composition and therefore grows uniquely. For example, paddy (or rice) requires high temperatures and high humidity conditions for optimal growth of the rice plant, whereas wheat requires lower temperatures and low humidity for its optimal growth. However, the growth conditions extremes, both low and high, may significantly reduce the plant cultivation and even lead to the death of the plant. Specifically, such uncontrolled growth conditions may limit the rate of photosynthesis required for producing the plant growth material. Therefore, beneficially, the automated indoor vertical cultivation system combines knowledge of the aforementioned growth parameters, to provide an optimal growth condition describing photosynthetic conditions that are optimal for the cultivation of a given plant.

Optionally, each of the multiple habitats are hermetically sealed chambers and are stacked on the at least one cultivation rack in at least one of: a vertical orientation, a horizontal orientation, a diagonal orientation, and a random orientation. The hermetically sealed multiple habitats prevent the contents therein from potential contaminants that may enter the multiple habitats. In this regard, each of the hermetically sealed multiple habitats prevents the entry of microorganisms and maintains sterility of the contents (such as restricting microbiological activity) therein. Moreover, it will be appreciated that each of the hermetically sealed multiple habitats is essential for the accurate and safe functionality of many electronic and automated arrangements operatively coupled to each of the multiple habitats. In an exemplary implementation, the cultivation racks may be stacked together in a vertical orientation to reduce space consumption. In such implementation, each of the multiple habitats may have a length, a width and a height of for example 10×5×6 feet. Moreover, each of the multiple habitats could be easily scaled up, scaled-down, or disassembled depending upon the usage thereof.

Optionally, the method further comprises operating an electrical power converter module of a power converter, associated with the indoor vertical cultivation system, that is able to adapt to local power voltage and frequency in order to provide electrical power for operating the indoor vertical cultivation system used for measuring, controlling and monitoring the optimal growth conditions in each of the multiple habitats. The term “power converter” as used herein refers to an electrical or electromechanical device for converting electric energy from one form to another, such as from alternating current (AC) to direct current (DC) and vice versa, change the voltage or frequency to current that is optimally suited for user loads, or perform any combination thereof. Optionally, the power converter may be a transformer, a resonant converter, an AC adapter, or any other suitable device. It will be appreciated that the power converter enables use of said indoor vertical cultivation system anywhere in a country or from one country to another. The term “electrical power converter module” refers to a set of instructions for operating the power converter as required. The electric power converter module is configured to adapt the power converter to convert suitably the voltage, frequency or current in order to provide electrical power to the indoor vertical cultivation system and the associated electrical components as required. Moreover, the multiple habitats are configured in a way that provides a power converter to each habitat by enabling the connection to different power voltage, phase, and frequency. It will be appreciated that each of the multiple habitats may require power for operating different arrangements for providing optimal growth conditions to the plants therein. Moreover, the power requirements may vary from plant to plant and therefore the electrical power converter module may operate the power converter to enable connection to different power voltage, phase, and frequency in each of the multiple habitats.

Optionally, the method further comprises operating a dehumidification module of a dehumidification arrangement, associated with the indoor vertical cultivation system, for producing the water necessary for cultivation as well as used during the harvesting of the plant, wherein the plant is dried prior to harvest. The term “dehumidification arrangement” as used herein refers to an arrangement that maintains the level of humidity in the air, by extracting excess water or water vapor from the air, such as the air inside the indoor vertical cultivation system. In other words, the dehumidification arrangement may be responsible to hold the values of relative humidity as low as possible. Moreover, each of the multiple habitats includes a separate dehumidification arrangement to remove excess humidity from the air, store and deliver the captured clean deionized water for re-use by each of the multiple habitats. Optionally, the dehumidification arrangement employs mechanical dehumidification (also known as refrigerative dehumidification) process that removes humidity by cooling the air (such as by using a cooling coil or a fan to cool the air) to condense the water vapour. The term “dehumidification module” refers to a set of instructions for operating the dehumidification arrangement as required, i.e. based on the available humidity and desired humidity in the indoor vertical cultivation system for cultivation as well as during harvesting of the plant. In other words, the dehumidification module is configured to adapt the dehumidification arrangement to modulate the humidity levels to meet the desired humidity requirements of a specific plant in the multiple habitats. Moreover, optionally, the dehumidification module may be responsible to sustain the correct control of the dehumidification arrangement, such as for a 24V AC power. Optionally, one or more humidifiers may be installed in parallel to the dehumidification arrangement depending upon the application of the indoor vertical cultivation system.

Optionally, the method further comprises operating a harvesting arrangement, associated with the indoor vertical cultivation system, for harvesting the plant having optimal growth. The harvesting arrangement enables the withdrawal of the cultivated plants from each of the multiple habitats of the indoor vertical cultivation system.

The term “software module” as used herein refers to a software program file that contains a set of instructions stored on a storage medium. In this regard, the software module is operatively coupled to various arrangements associated with the indoor vertical cultivation system for measuring, controlling and monitoring the optimal growth conditions in each of the multiple habitats. Moreover, the software module is capable of continual learning and improvement based on a cultivation cycle, namely a harvesting schedule, associated with the plant.

Moreover, the software module is configured to obtain, from a database, and use a data associated with the plant in each of the multiple habitats, wherein the data corresponds to at least one of: a name, a growth condition, a unique tag number, and a harvesting schedule of the plant, and wherein each of the multiple habitats are on a different harvest schedule. The term “database” as used herein refers to an organized collection of structured information, or a data, typically stored electronically in the system. More optionally, the database may be hardware, software, firmware, and/or any combination thereof. For example, the organized body of digital information may be in a form of a table, a map, a grid, a packet, a datagram, a file, a document, a list or in any other form. The database includes any data storage software and system, such as, for example, a relational database like IBM DB2, MySQL, SQL Server, and Oracle 9. Optionally, the database is communicably coupled to the software module via a communication network. In an example, the communication network includes but is not limited to, a cellular network, short-range radio (for example, such as Bluetooth®), Internet, a wireless local area network, and an Infrared Local Area Network, or any combination there.

The term “data” as used herein refers to information or a set of values of qualitative or quantitative variables that has been translated into a form that is efficient for processing. Typically, the data relates to an identity, such as a name, and specific details, such as growth conditions, associated with a plant. The term “name” as used herein refers to the identification or reference of the plant. Typically, the name may comprise a word, a set of words, or alpha-numeric identification of the plant. Optionally, the name may be a biological name or a common name of the plant. As discussed above, the term “growth condition” as used herein refers to various environmental conditions, such as temperature, humidity, air quality, light, nutrients, water vapour size, pH, biological oxygen demand, total dissolved solids, carbon dioxide level, and electrical conductivity, required for the growth of the plant.

The term “unique tag number” as used herein refers to a unique and distinct number assigned to each plant to enable identification thereof in the system. Moreover, the unique tag number is recorded in the software module so that it can be uniquely identified during the vegetative phase through the harvest phase of a given plant. Moreover, the unique tag number enables tracking of the location and or batch of the plant product. The unique tag number may be determined using standard analytical laboratory equipment that measures minerals and or metals such as an inductively coupled plasma mass spectrometry (ICP-MS). Furthermore, the unique set of nutrients are measured to coincide with a unique tag number so that the plant can later be traced back to a specific location or batch from which it was produced.

The term “harvesting schedule” as used herein refers to a decision-making process that specifies where to harvest, when to harvest and how much to harvest in the automated indoor vertical cultivation of plants to achieve the desired yield. Additionally, the harvest data may include the date that the plant was planted with seed (or other plant material such as the plant cuttings or the plant tissue culture), the population of planted seeds (or other plant material such as the plant cuttings or the plant tissue culture) per specified area, nutrient requirement thereby, and anticipated temporal harvest data such as an expected harvest date or a harvest window. Optionally, the data associated with the plant may also include, but not limited to, planting information such as plant depth and width.

Moreover, the software module is configured to operate a water supply arrangement and an air sanitization arrangement, operatively coupled to each of the multiple habitats, to provide optimized a water supply and clean air, respectively, thereto. Moreover, optionally, the software module is further configured for operating:
a root chamber environment modulation arrangement, operatively coupled to each of the multiple habitats, to provide optimized water with pH, electrical conductivity and optimal nutrients thereto;
a light supply arrangement, operatively coupled to each of the multiple habitats, to provide an optimal light intensity thereto; and
an air conditioning arrangement, operatively coupled to each of the multiple habitats, to provide an optimal air temperature and humidity thereto.

In this regard, the term “water supply arrangement” as used herein refers to an arrangement for supplying water to the multiple habitats. Optionally, the water is clean (or treated) water. Optionally, the water is a deionized water. In this regard, optionally, the water supply arrangement is operatively coupled to the dehumidification arrangement, and wherein the dehumidification arrangement collects moisture from the air, stores and delivers the captured clean deionized water, via the water supply arrangement, to each of the multiple habitats. As discussed above, the dehumidification arrangement is operable to return the excess water from the air to the water supply arrangement for re-use thereof in cultivation of plants. In this regard, the deionized water is provided either as spray or mist to the plants. Optionally, the water supply arrangement may be implemented as a fogger. Optionally, the software module operates the water supply arrangement based on the data received from the database that indicates that the optimal water requirement by the plant in each of the multiple habitats.

The term “air conditioning arrangement” as used herein refers to an electrical device that modulates air temperature and humidity, such as by removal or addition of heat and moisture, in the multiple habitats. Optionally, the air conditioning arrangement may manage air temperature by utilizing a closed-loop water convection mechanism that continuously circulates chilled water through a fan or cool coil within the habitat thereby further managing the humidity therein. Optionally, each of the multiple habitats is completely self-contained and automated for cultivation of plants utilizing air conditioning arrangement. The term “air sanitization arrangement” as used herein refers to a device for cleaning, by way of disinfecting for example, the air present inside each of the multiple habitats. It will be appreciated that the air sanitization arrangement provides better end products at the end of the cultivation.

Optionally, the air sanitization arrangement employs a series of filters and an ultraviolet germicidal irradiation designed to trap and destroy the virus, bacteria, mold, pest, and other contaminants to a 99.99% success ratio. While the series of filters trap the microorganisms in the air, the ultraviolet germicidal irradiation kills or inactivates the trapped microorganisms. The term “ultraviolet germicidal irradiation” as used herein refers to a disinfection method that uses short-wavelength ultraviolet (namely, ultraviolet C (UV-C)) light, in a wavelength range of 240 to 850 nanometre, to kill or inactivate microorganisms by destroying nucleic acids and disrupting their DNA, leaving them unable to perform vital cellular functions. In this regard, the ultraviolet germicidal irradiation creates an effective pathogen destruction environment in the system. Beneficially, the air within the each of the multiple habitats is circulated continually to ensure 99.9% capture and destruction of pathogens including bacteria, virus, and particulate matter including insect, pollen, and mold spore, therein. Moreover, the ultraviolet germicidal irradiation has various applications, such as in food, air, and water purification. In this regard, the ultraviolet germicidal irradiation may be coupled with other filtration arrangements to sanitize air and water, thereby creating inhospitable environments for the aforementioned microorganisms.

Optionally, the ultraviolet germicidal irradiation is generated from at least one of: a UV bulb and a biocidal film reflective panel. The UV bulb may be a UV-C bulb, a UV-C LED or a UV-C lamp, that can be integrated in an irradiation region of an air sanitization arrangement for producing ultraviolet germicidal irradiation for disinfecting air in the multiple habitats. Typically, the UV bulb generate UV-C light in a wavelength range of 207 to 222 nanometre that kills pathogens without harming human tissues. The UV-C LEDs typically generate UV-C light in a wavelength range of 255 to 280 nanometre. The biocidal film reflective panel may comprise for example silver, titanium dioxide (TiO₂), silver-titania composite, and other antibacterial, antiviral, antifungal materials.

The term “root chamber environment modulation arrangement” as used herein refers to an arrangement used for modulating optimal growth conditions inside the root chamber of the system to specifically target roots of the plant for an efficient acquisition of water and nutrients supplied thereto. Moreover, the water supply arrangement, the air conditioning arrangement and the air sanitization arrangement may be operatively coupled to the root chamber environment modulation arrangement to direct the water, the nutrients, and the clean air with optimal temperature towards the roots of the plant. Furthermore, the said arrangement ensures rapid root development, increased yield, and shorter cultivation cycle time by providing optimal environment for the development of the roots that may be different from the requirement of the plant stem or leaves. Moreover, the root chamber environment modulation arrangement is configured to maintain an optimal temperature of the root chamber to enable efficient root development. It will be appreciated that the temperature requirement for the root development is different from development of other parts of the plant such as the leaves and stem thereof. In this regard, the root chamber environment modulation arrangement may be synchronized with the software module associated with the indoor vertical cultivation system for modulating temperature conditions in each of the multiple habitats for effective development of roots of the plant. Optionally, the root chamber environment modulation arrangement is configured to modulate the water supply arrangement to continuously or intermittently spray water comprising nutrients onto the plant root in the root chamber of the multiple habitats, based on the data obtained by the software module from the database.

The term “light supply arrangement” as used herein refers to an arrangement for providing optimal light in the multiple habitats to enable photosynthesis in plants. In this regard, the light supply arrangement includes at least one of a light emitting diode (LED), laser lights and/or a natural light source, wherein the light source in operation regulates at least one of: a light intensity, a light quality, a wavelength of light, and a duration of light exposure. Optionally, the light intensity may be raised or lowered in the nanometre range. In an embodiment, the light supply arrangement is operable to increase or decrease the light intensity to maintain the light intensity in the wavelength range of 240 nm to 850 nm within the system. It will be appreciated that the light intensity of the LED may vary from one plant to another. Herein the light intensity relates to the intensity or concentration of light. The natural light (or sunlight) varies in its intensity with the season of the year. The light intensity is measured in the number of photons fed to the plant per unit area per second (or μmol/m²/s). Moreover, light intensity varies with different species and with different growth stages. Beneficially, the said optimization of the method for indoor cultivation of plants enables the plants to be grown all year with consistent quality. Optionally, the light supply arrangement may be providing light conditions that are less favourable for the development of plant diseases, pathogens, molds, and so forth. Optionally, in addition to automatic adjustment of the light intensity, the light supply arrangement contributes to additional heat into the indoor vertical cultivation system that may be addressed by the air conditioning arrangement, as discussed above. Optionally, the light supply arrangement may require 0-10V power for the operation thereof.

Optionally, the software module is further configured for measuring, by using a sensor arrangement, a set of growth conditions within each of the multiple habitats of the indoor vertical cultivation system. The term “sensor arrangement” as used herein refers to at least one sensor or a group of sensors, usually deployed in the system for measuring various signals associated with a set of growth conditions inside the indoor vertical cultivation system, or specifically in each of the multiple habitats. In this regard, a set of growth conditions may be measured, continuously or intermittently, within each of the multiple habitats. It will be appreciated that the sensor arrangement is operatively coupled with the software module to provide the sensor data thereto.

Optionally, the sensor arrangement comprises at least one of: a gas concentration sensor, a temperature sensor, a humidity sensor, a total dissolved solids sensor, a water particle size sensor, a water temperature sensor, a pH senor, an electrical conductivity sensor, a light sensor and a plant colour sensor. Typically, the gas concentration sensor determines in operation relative concentrations of at least two of: carbon dioxide gas, oxygen gas, nitrogen gas, methane gas, Sulphur dioxide gas, and carbon monoxide gas, within the indoor vertical cultivation system. Moreover, the temperature sensor, the humidity sensor, and the light sensor determine in operation the temperature, the humidity, and the illumination describing the growth conditions required for the automated indoor cultivation of the plants within the indoor vertical cultivation system, respectively. Furthermore, the total dissolved solids sensor determines the amount of salt and minerals present in a nutrient solution inside the multiple habitats. Optionally, the total dissolved solids sensor is an electrical charge meter whereby two electrodes equally spaced apart are inserted into the water and used to measure charge. Additionally, the measured charge is converted into parts per million (ppm) value.

The pH sensor measures the hydrogen-ion activity in water-based solutions, indicating its acidity or alkalinity, expressed as pH, of the water nutrients solution suitable for the plants. Specifically, the pH sensor is used to monitor the pH balance of the water nutrients solution depending on the requirements of the plants. For example, the pH value greater than 7 will represent that the pH is alkene whilst the pH value smaller than 7 will represent that the pH is acidic. Optionally, for any significant increase or decrease of pH value, clean water or more nutrient solution may be added to the habitat to meet the optimal requirements of pH of water for cultivation of plants. Optionally, the pH of the nutrient solution in a range of 5.5-8.0, optionally 7 ensures an effective nutrient availability to the plants.

The term “water particle size sensor” as used herein refers to a sensor used for measuring the size of water particles in the system. It will be appreciated that the water particle size sensor ensures optimal substrate wettability of the plant in the multiple habitats. Notably, substrate wettability is an important factor in determining effective and efficient irrigation techniques for indoor cultivation of the plants. Optionally, reduced substrate wettability may lead to lower substrate water capture, excessive leaching, and poor plant growth. Optionally, the plants best absorb particles in a range from 1-50 μm. Typically, the absorption rate, as well as the energy required to grow the plants are inversely proportional to particle size. Moreover, the system employs the water temperature sensor to measure the temperature of the water in the habitat.

The term “plant colour sensor” as used herein refers to a sensor that is used to detect the colour of the plant (for example, leaf of the plant). It will be appreciated that the plant colour sensor detects colour and categorize the colour as in RBG (red, blue, or green) scale. Moreover, the plant colour sensor may also be equipped with filters to reject the unwanted IR light and UV light. Colour sensors contain a white light emitter to illuminate the surface. Optionally, three filters with wavelength sensitivities at 580 nm, 540 nm, 450 nm is used to measure the wavelengths of red, green, and blue colours respectively. Furthermore, based on the activation of the filters, the colour of the plant is categorized. Optionally, a light to voltage converter is also present in the plant colour sensor. The plant colour sensor responds to colour by generating a voltage proportional to the detected colour. Optionally, the sensor arrangement may determine the optimal growth conditions at predefined time durations, such as at time durations in a gap of at least one of: 30 minutes, 1 hour, 2 hours, 1 day, and so forth. Beneficially, automated sensing by the sensor arrangement, enables a reduction in direct and frequent human interventions (or physical efforts) by a user of the indoor vertical cultivation system.

Optionally, the software module is further configured for controlling, by using a controller arrangement, at least one growth condition from the set of growth conditions to achieve the optimal growth conditions in each of the multiple habitats for growing the plant. In this regard, the term “controller arrangement” as used herein refers to an arrangement that could command, direct or regulate one or more associated arrangements communicably coupled to the indoor vertical cultivation system to achieve a desired value of at least one growth condition from the set of growth conditions in the indoor vertical cultivation system. The desired value of at least one growth condition is the optimal value associated with a given at least one growth condition required for growing the plant in each of the multiple habitats. Moreover, the controller arrangement minimizes the difference between the actual value of at least one of the growth conditions in the system (i.e. the process variable) and the optimal value thereof in each of the multiple habitats. Specifically, the controller arrangement is operable to obtain at least one growth condition describing photosynthetic conditions that are optimal for cultivation of the plants, by communicating with the software module communicably coupled to the database, and compare the obtained data with the at least one growth condition describing photosynthetic conditions received from the sensor arrangement. In an example, the controller arrangement may be operable for controlling atmospheric conditions, such as increased levels of gases other than carbon dioxide. In such example, the controller arrangement may be operable for replacing the air inside each of the multiple habitats in a condition where the level of the other gases becomes harmful for the cultivation of the plants. In another example, the controller arrangement may also be operable for controlling the humidity inside each of the multiple habitats by re-circulating gases using the dehumidification arrangement. Optionally, the controller arrangement may be communicably coupled to the database.

Optionally, the software module is further configured for operating the controller arrangement for communicating with
the water supply arrangement, for supplying water supply;
the dehumidification system, operatively coupled to the water supply arrangement, for supplying clean deionized water, via the water supply arrangement, to each of the multiple habitats;
a nutrient supply arrangement, operatively coupled to the water supply arrangement, for supplying nutrients with the water supply;
the air conditioning arrangement, corresponding to each of the multiple habitats, for providing an optimal heating and cooling conditions for growing plants; and
the light supply arrangement, corresponding to each of the multiple habitats, for providing an optimal light for growing plants;
the air sanitization arrangement, corresponding to each of the multiple habitats, for providing clean air conditions for growing plants;
a carbon dioxide arrangement, corresponding to each of the multiple habitats, for providing an optimal supply of carbon dioxide for growing plants; and
a power source arrangement, corresponding to each of the multiple habitats, for providing a power converter to each habitat by enabling the connection to different power voltage, phase, and frequency.

In this regard, the controller arrangement communicates with various arrangements to control at least one growth condition to achieve the optimal growth conditions in each of the multiple habitats for growing the plant. The controller arrangement communicates with the water arrangement and the dehumidification arrangement to provide clean deionized water to the multiple habitats as and when required. Moreover, the nutrient supply arrangement supplies nutrients desired for the growth of plants, via the water supply, by working in conjunction with the water supply arrangement. Optionally, the nutrients are selected from a set of macronutrients and micronutrients, and wherein the set of macronutrients and micronutrients are unique for a given plant. Moreover, the nutrient supply arrangement mixes the required amount of each of the micronutrients and the macronutrients to be automatically fed to the water supply arrangement. Furthermore, the nutrient supply arrangement supplies the micronutrients and the macro nutrients, via the water supply, to the plants based on their specific nutrient schedule.

Moreover, the controller arrangement may instruct the air conditioning arrangement to determine the temperature within the system, using the temperature sensor, and modulating the same based on the optimal temperature required for growth of the plants. Optionally, the air conditioning arrangement may maintain the temperature in a range of 3° C. to 50° C., optionally in a range of 25° C. to 30° C. within the indoor vertical cultivation system. Moreover, a temperature around 20° C. with a slight variation of ±10% allows for cultivating the plants under regulated photosynthetic conditions and/or extreme conditions ranging from mild to extreme cold or hot conditions. It will be appreciated that the higher temperatures result in a higher consumption rate of carbon dioxide gas.

Moreover, the controller arrangement may instruct the light supply arrangement to providing an optimal light to each of the multiple habitats for growing plants. Optionally, the optimal light is provided using a light source selected from at least one of: a light emitting diode (LED), a laser light, a UV-light, and/or a natural light source (i.e. sun), wherein the light source in operation regulates at least one of: a light intensity, a light quality, a wavelength of light, and a duration of light exposure. Optionally, the light source emits a visible, an ultraviolet (UV) and/or near infrared light spectrum for selective illumination of a target area (namely, various growth stages) within the multiple habitats. More optionally, the light source is operable to increase or decrease the light intensity to maintain the light intensity in the wavelength range of 240 nm to 850 nm. Moreover, UV-light may further enable sterilization of seeds, plant cutting or plant tissue culture and the plant growth material to prevent mould growth thereon. Optionally, a plurality of optics, such as lens, mirrors (for example, micro-electro-mechanical (MEM) mirrors), prisms, collimation optics, a liquid crystal (LC) optic for beam steering, a Switchable Bragg Grating (SBG) and the like, and/or combination thereof, may be suitably positioned to direct light from the light source to selectively illuminate the region within the field of view in the multiple habitats.

The term “carbon dioxide arrangement” as used herein refers to an arrangement that enables the supply of carbon dioxide in the multiple habitats for ensuring optimal growth of the plants. It will be appreciated that the gas concentration sensor provided in the indoor vertical cultivation system is operatively coupled with the controller arrangement that controls the operation of the carbon dioxide arrangement to provide optimal carbon dioxide concentration within each of the multiple habitats of the indoor vertical cultivation system. It will be appreciated that the carbon dioxide arrangement contributes to additional heat as a result of the carbon dioxide in the indoor vertical cultivation system. However, said increase in temperature due to carbon dioxide concentration may be addressed by the air conditioning arrangement as the controller arrangement is communicably coupled to the air conditioning arrangement and the carbon dioxide arrangement.

The term “power source arrangement” as used herein refers to a network of electrical components deployed to supply electric power to the indoor vertical cultivation system and associated arrangements. The power source arrangement comprises the power converter that enables the connection to different power voltage, phase, and frequency in each of the multiple habitats to operate various arrangements configured to provide optimal growth conditions for the plants in each of the multiple habitats. In this regard, the controller arrangement communicates with the power source arrangement to power each of the multiple habitats based on the data received by the software module from the database and communicated to the controller arrangement.

It will be appreciated that the disclosed method for indoor vertical cultivation of plants is advantageous in that it reduces the overall carbon footprint by minimizing (or completely preventing) release of carbon dioxide in the environment, thereby checking on the global warming resulting from greenhouse gas (such as carbon dioxide, methane, and so forth) emission. As mentioned above, carbon dioxide is utilized by the plants to grow and generate oxygen consumed by human, animals and adding up to atmospheric oxygen content. Notably, the traditional agriculture methods, using soil, account for a considerable amount of global greenhouse gas emission. Reportedly, as per a new analysis by the Food and Agriculture Organization of the United Nations (https://news.un.org/en/story/2021/11/1105172), 16.5 billion tonnes of greenhouse gas emissions results from farm gate (7.2 billion tonnes), land use change (3.5 billion tonnes) and supply-chain processes (5.8 billion tonnes). In 2019, deforestation was the largest source of GHG emissions, followed by livestock manure, household consumption, food waste disposal, fossil fuels used on farms and the food retail sector. Based on a new analysis (https://ourworldindata.org/emissions-by-sector), agriculture, forestry and land use directly account for 18.4% of global greenhouse gas emissions, of which agriculture contributes to a total of 12.6%, from grasslands (0.1%), cropland (1.4%), deforestation (2.2%), crop burning (3.5%), rice cultivation (1.3%) and agricultural soils (4.1%), of global greenhouse gas emissions.

Therefore, the indoor vertical cultivation of plants is a step towards reducing carbon footprint by removing soil-based cultivation of plants, reducing the amount of water and land required to produce same or higher amount of plant material, as well as reducing the use of chemicals, pesticides and long transportation durations of the plant material and associated carbon footprint. Moreover, the indoor vertical cultivation of plants using the indoor vertical cultivation system employs energy-efficient sources, such as LEDs light sources, that are much more energy efficient and cut down on the greenhouse gas emission even further. Furthermore, the light supply arrangement may be configured to use renewable energy sources or low-carbon energy sources to produce electricity for powering the indoor vertical cultivation system.

Optionally, the software module is further configured for monitoring, by using a camera arrangement, the growth of the plant during the entire life cycle from a vegetative phase of the plant through a harvesting phase of the plant in each of the multiple habitats. The term “camera arrangement” as used herein refers to an arrangement having one or more cameras or one or more image sensors that may be used to capture one or more images of the plant. In this regard, the camera arrangement is operatively coupled to the software module for monitoring the growth of the plant during the entire life cycle from the vegetative phase of the plant through the harvesting phase of the plant in each of the multiple habitats. It will be appreciated that the habitat may have an IoT camera for sporadic inspections and also screen captures. Beneficially, the camera arrangement may conduct a time-lapse video that may be handled by the cloud application. The images refers to visual representations of the plants, captured by the camera arrangement that may be saved in the database. For example, the camera arrangement may be a hyperspectral camera, that allows images to be divided into many spectral bands, and led to the development of vegetation indices that could be used to estimate the growth conditions such as biomass, chlorophyll content, and leaf area index. For example, the onion yield predictions could be made using RGB images which are processed to determine plant height and volume using various software applications. Additionally, multiple consecutive depth maps are merged to obtain a smooth resulting image of the plant. The said merging enables monitoring of the growth of the plants even though the camera arrangement is fixed, and captures images such as natural flickering of the light supplied, movement of leaves and change in their colour, and so forth. Beneficially, the camera arrangement may be mounted inside the system to detect and identify spot disease in the growth of the plant during the entire life cycle of the plant in the multiple habitats, in real-time.

Optionally, the software module comprises standard operating procedures and process flows associated with the cultivation of the plants. In this regard, the standard operating procedures and process flows are guidelines for the efficient automated indoor vertical cultivation of the plants. Beneficially, the software module is multi-lingual and is able to meet multiple jurisdictional requirements related to food safety and standards. Additionally, beneficially, the software module comprises standard operating procedures and process flow associated with the plants to meet (and, preferably, exceed) that can flex to meet both standard good manufacturing practice (GMP), and other higher pharmaceutical level standards such as the European Union good manufacturing practice (EU GMP) compliance standards. In so doing, the habitats can remain plant agnostic and include plants that may be cultivated for processing into medical grade products. The said, “GMP practices” differ widely from industry to industry to prevent harm from occurring to the user, including that the end product is free from contamination, and the packaging, as well as manufacture, has been well documented. In this regard, the international and sovereign national GMP standards include basic principles such as, the manufacturing processes are clean, controlled and processes are verifiable and repeatable, changes to the processes must also be documented, record keeping, accurate accounting (of product and on the financial side) must be kept, including a complete batch history through manufacture and distribution to the end-user, all complaints about products must be examined, and so forth. By being able to manage multiple GMP standards, the final plant product can be said to be “country interoperable” meaning it is able to more easily cross international boarders if required to do so.

Optionally, the software module is trained using artificial intelligence tools. The term “artificial intelligence tools” as used herein relates to a computationally intelligent system that combines knowledge, techniques, and methodologies for controlling a bot or other programmable arrangements within a computing environment. Furthermore, the artificial intelligence tool is configured to apply the knowledge that can adapt itself and learn to do better in changing environments. The artificial intelligence tools include logic engines, decision-making engines, pre-set targeting accuracy levels, and/or programmatically intelligent software. Optionally, the artificial intelligence tools enable data gathering of the plants grown all over the world to provide consistently repeatable crops that are independent of geographic climate. Moreover, the software module may be used to improve growing parameters over time, detect adverse conditions early, and eliminate the need for specialized knowledge required by the user or operator. Optionally, the software module is a set of one or more software applications. However, each software application serves a unique and separate operation, as mentioned above. Optionally, the software module may be pre-installed on the system or can be downloaded from a client network, a remote data storage, or the internet. The software modules may be a System, Applications and Products (SAP) module, an enterprise resource planning (ERP) software, and so on.

In one example, if on a given day, the order of scanning the regulated growth condition changes or the intervals between each scan substantially change, the artificial intelligence tools or machine learning algorithms may raise a flag or an alarm to the user (or operator of the system). In this regard, the software module continually collects several data points from each of the multiple habitats, for measuring, monitoring and controlling the indoor vertical cultivation system. In an example, the camera arrangement of the indoor vertical cultivation system may use a machine learning process in MATLAB or an XML (an image trained file) file for spotting disease in the plant.

Optionally, the software module provides a secure communication between the indoor vertical cultivation system and associated components therewith, and wherein providing secure communication comprises receiving access authorization information from a secure cloud-based server, and allowing access to the software module only for software components identified by the access authorization information. In this regard, the controller arrangement sends the data to the secure cloud-based server, using an Internet of things (IoT) Core service, the data is read, and based on an established rule the data is stored with the desired structure in the database. Optionally, the secure cloud-based server may be a Meraki MX68® cloud-based security appliance employed in the system. The Meraki MX68® has zero-touch provisioning that aids automatic deployment. Beneficially, the secure cloud-based server eliminates the need for manual configuration of the network and security appliances. It will be appreciated that said server features an Intrusion Prevention System that detects and neutralizes malicious incidents. Moreover, the database stores all the data from the sensor arrangement, events that have occurred in the habitats, as well as the sensor configurations for the correct operation of each part of the habitats. Optionally, the secure cloud-based server may use Amazon Web Services® (such as AWS® Lambda service) for extracting the data from the database and sending the data through an API Gateway to a computer operating system, namely software module. Optionally, the software module enable users to have access to dashboards of the habitats to set the optimum values of the sensors and thereby controlling the habitats based on the values sent by the sensors or plant data available on the database, to allow optimal growth of the plants in the habitats.

It will be appreciated that based on the amount of the controller arrangements per cultivation rack, a specific number of ports are employed in the indoor vertical cultivation system for providing a means of effective communication between the multiple habitats and the controller arrangement. Optionally, the specific number of ports may include active ports, passive ports, access points, customer-premises equipment (CPE), Uplinks (active and back-up), and so forth. Optionally, the controller arrangement may include a network switch (such as multi-port Dummy Switch) that helps cascade the communication between rows inside the cultivation rack. The controller arrangement may also include a Connectivity and Traffic (Internet Access) to access specific rows inside the cultivation rack and the controller arrangement. Optionally, to ensure smooth functioning of internet connection, a failover diagram may be created based on connectivity and the communication between the cultivation racks and an IT Network main rack.

Optionally, the indoor vertical cultivation system may comprise at least two ISPs to ensure that when a first ISP goes down, then a second ISP may be used as a backup for making sure that the internet connection is always up. Moreover, optionally, the indoor vertical cultivation system may comprise multiple fully managed Gigabit switches such as UniFi® 24 Ports PRO Gen2 Switches for delivering robust performance and intelligent switching for maintaining internet connectivity. Optionally, a high-performance, indoor/outdoor Access Point AC Pro (UAP AC Pro) may be employed in the controller arrangement to provide a Wi-Fi® access point that utilizes Wave 1 technology to reach an impressive 2+ Gbps aggregate throughput rate with its 5 GHz (3×3 MIMO) and 2.4 GHz (3×3 MIMO) bands. Optionally, a software architectural style such as a Representational state transfer application programming interface (REST API) is used to guide the design and development of the architecture of the aforementioned arrangements for the information system (such as World Wide Web).

It will be appreciated that the cloud-based server is used to handle the alarms and events that are generated from the system. In this regard, the cloud-based server may also generate and manage an SMS or email alert to the administrator or maintainers to take action. Beneficially, the cloud-based server may generate insights into the data that is stored in the database. Optionally, the cloud-based server may manage a fleet and also could serve to execute mass deployment of the habitat's applications with ease. For example, if half of the habitat is with a specific grow plan then the user may go directly with the deployment managed by the cloud-based server and the fleet and deploy the application seamlessly. Optionally, for limiting bandwidth, the system network architecture may be different than the control architecture. In this regard, a different VLAN is employed for streaming instead of the control VLAN.

Optionally, the software module may be stored in a tangible computer-readable storage device in connection with the necessary hardware components, such as the processor, bus, display, and so forth, to carry out a particular function. In another aspect, the system may use a processor and computer-readable storage device to store instructions which, when executed by the processor, cause the processor to perform operations, a method, or other specific actions. Optionally, the system may use other types of computer-readable storage devices which can store data that are accessible by a computer, such as magnetic cassettes, flash memory cards, digital versatile disks (DVDs), cartridges, random access memories (RAMs), read-only memory (ROM), a cable containing a bit stream and the like, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

Optionally, the computer program product may employ artificial intelligence to continually optimize the aforementioned method to reduce water, power and cycle time while increasing yield weight, improving crispness, flavour and/or shelf life through the measurement, collection, management, analysis, and correlation of the data collected during the run of the aforementioned method. As discussed above, the artificial intelligence enables continuously optimizing the methods of cultivation of plants in optimal growth conditions based on the data available in the database as accessed by the software module.

The present disclosure also relates to the system as described above. Various embodiments and variants disclosed above apply mutatis mutandis to the system.

Optionally, the at least one cultivation rack is a movable rack.

Optionally, each of the multiple habitats are hermetically sealed chambers and are stacked on the at least one cultivation rack in at least one of: a vertical orientation, a horizontal orientation, a diagonal orientation, and a random orientation.

Optionally, the indoor vertical cultivation system further comprises
a sensor arrangement for measuring a set of growth conditions within each of the multiple habitats of the indoor vertical cultivation system;
a controller arrangement for controlling at least one growth condition from the set of growth conditions to achieve the optimal growth conditions in each of the multiple habitats for growing the plant;
a camera arrangement for monitoring the growth of the plant during the entire life cycle from a vegetative phase of the plant through a harvesting phase of the plant in each of the multiple habitats;
the water supply arrangement, for supplying the water supply;
a dehumidification system, operatively coupled to the water supply arrangement, for supplying clean deionized water, via the water supply arrangement, to each of the multiple habitats, wherein the dehumidification system collects moisture from the air, stores and delivers the captured clean deionized water to be supplied with the water supply necessary for cultivation as well as used during the harvesting of the plant, wherein the plant is dried prior to harvest;
a nutrient supply arrangement, operatively coupled to the water supply arrangement, for supplying nutrients with the water supply, wherein the nutrients are selected from a set of macronutrients and micronutrients;
a root chamber environment modulation arrangement, operatively coupled to each of the multiple habitats, to provide optimized water with pH, electrical conductivity and optimal nutrients thereto;
an air conditioning arrangement, corresponding to each of the multiple habitats, for providing an optimal heating and cooling conditions for growing plants; and
a light supply arrangement, corresponding to each of the multiple habitats, for providing an optimal light for growing plants
a carbon dioxide arrangement, corresponding to each of the multiple habitats, for providing an optimal supply of carbon dioxide for growing plants;
a power source arrangement, corresponding to each of the multiple habitats, for providing a power converter to each habitat by enabling the connection to different power voltage, phase, and frequency, wherein an electrical power converter module of the power converter, that is able to adapt to local power voltage and frequency, provides electrical power for operating the indoor vertical cultivation system used for measuring, controlling and monitoring the optimal growth conditions in each of the multiple habitats, and wherein the multiple habitats are configured in a way that provides a power converter to each habitat by enabling the connection to different power voltage, phase, and frequency;
a database for providing the software module a data associated with the plant in each of the multiple habitats, wherein the data corresponds to at least one of: a name, a growth condition, a unique tag number, and a harvesting schedule of the plant, and wherein each of the multiple habitats are on a different harvest schedule; and
a harvesting arrangement, associated with the indoor vertical cultivation system, for harvesting the plant having an optimal growth.

Optionally, the sensor arrangement comprises at least one of: a gas concentration sensor, a temperature sensor, a humidity sensor, a total dissolved solids sensor, a water particle size sensor, a water temperature sensor, a pH senor, an electrical conductivity sensor, a light sensor and a plant colour sensor.

Optionally, the air sanitization arrangement employs a series of filters and at least one of: a UV bulb and a biocidal film reflective panel to generate an ultraviolet germicidal irradiation designed to trap and destroy virus, bacteria, mold, pest and other contaminants to a 99.99% success ratio.

The present disclosure also relates to the computer program product as described above. Various embodiments and variants disclosed above apply mutatis mutandis to the computer program product.

A computer program product comprising a non-transitory computer-readable storage medium having computer-readable instructions stored thereon, the computer-readable instructions being executable by a computerized device comprising processing hardware to execute the aforementioned method.

A computer program product that employs artificial intelligence to continually optimize the aforementioned method to reduce water, power and cycle time while increasing yield weight, improving crispness, flavour and/or shelf life through the measurement, collection, management, analysis, and correlation of the data collected during the run of the aforementioned method.

### Detailed Description of Drawings

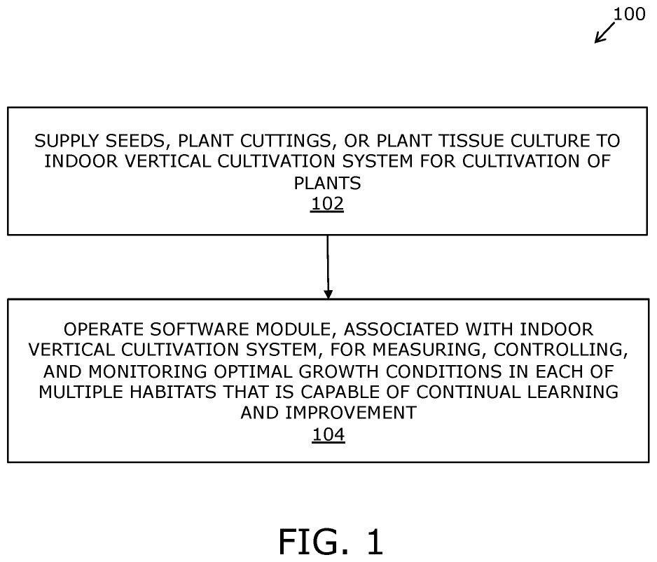

Referring to FIG. 1, there is illustrated a flowchart 100 of steps of a method for automated indoor vertical cultivation of plants, in accordance with an embodiment of the present disclosure. At step 102, seeds, plant cuttings, or plant tissue culture, are supplied to an indoor vertical cultivation system for cultivation of plants. The indoor vertical cultivation system comprises at least one cultivation rack configured to house multiple habitats. Moreover, each of the multiple habitats is configured to grow the plants under optimal growth conditions unique to the plant therein. At step 104, a software module, associated with the indoor vertical cultivation system, is operated for measuring, controlling and monitoring the optimal growth conditions in each of the multiple habitats that is capable of continual learning and improvement. Moreover, the software module is configured to operate a water supply arrangement and an air sanitization arrangement, operatively coupled to each of the multiple habitats, to provide a water supply and clean air, respectively, thereto.

The steps 102 and 104 are only illustrative and other alternatives can also be provided where one or more steps are added, one or more steps are removed, or one or more steps are provided in a different sequence without departing from the scope of the claims herein.

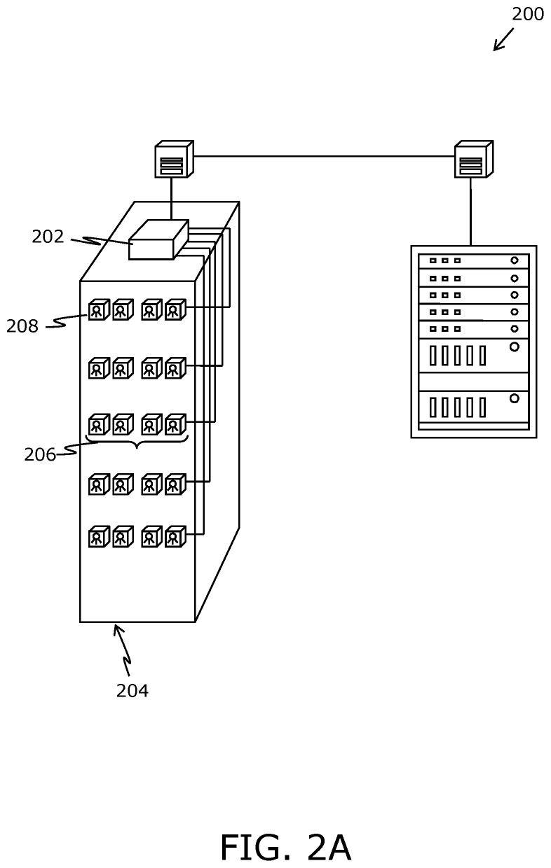

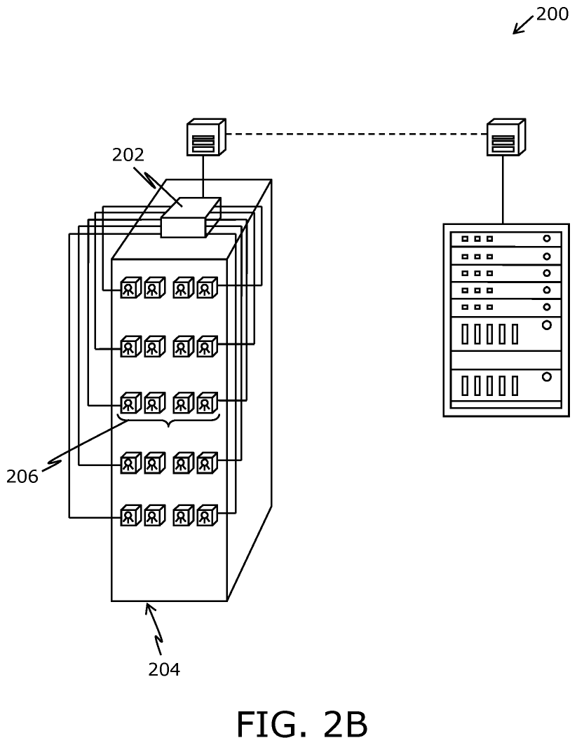

Referring to FIGS. 2A and 2B, there is shown a schematic illustration of the controller connectivity without and with failover, respectively, in accordance with an embodiment of the present disclosure. The indoor vertical cultivation system 204 comprises at least one cultivation rack 206 configured to house multiple habitats 208. As shown in FIG. 2A, the controller arrangement 202 communicates individually with various arrangements arranged with the multiple habitats 208. As shown in FIG. 2B, the controller arrangement 202 communicates individually with various arrangements arranged with the multiple habitats 208 which also communicate with each other over manageable switches extended by failover.

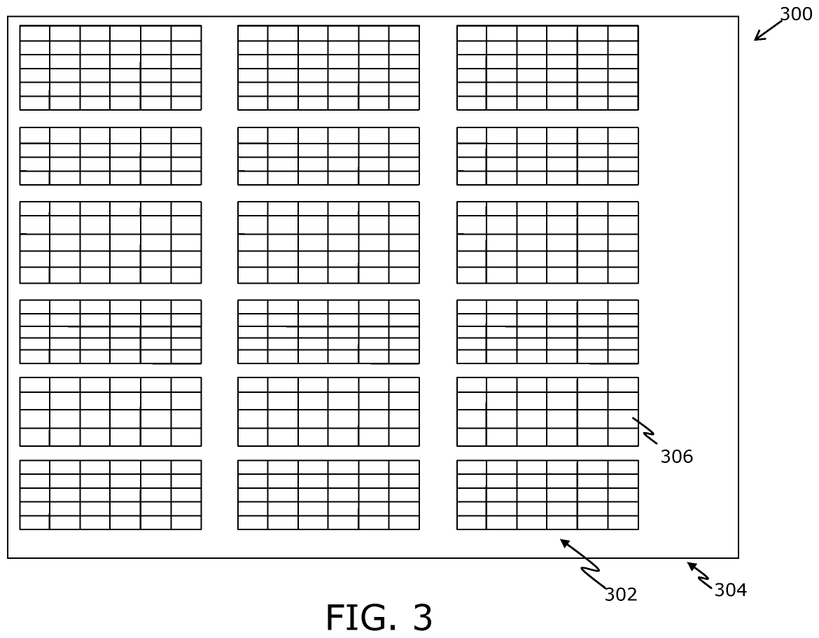

Referring to FIG. 3, there is shown a top view of a floor plan 300 of the cultivation racks 302 of the indoor vertical cultivation system 304, in accordance with an embodiment of the present disclosure. Moreover, the at least one cultivation rack 302 is configured to house multiple habitats 306, wherein each of the multiple habitats 306 is configured to grow the plants under optimal growth conditions unique to the plant therein.

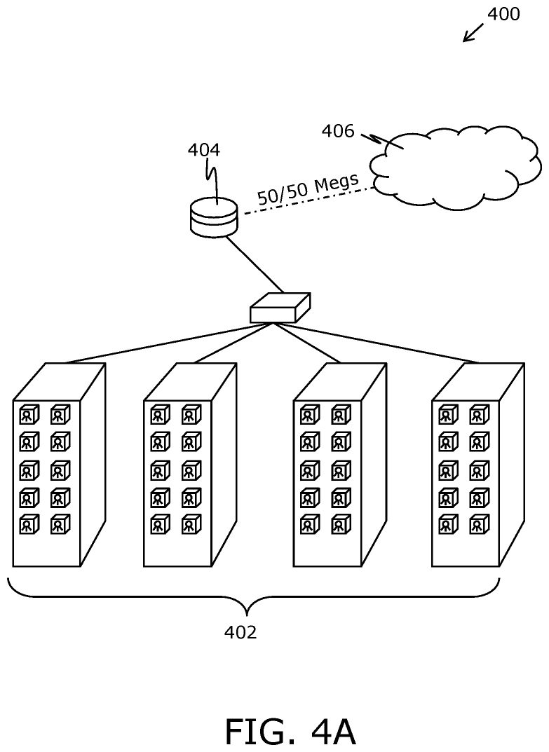

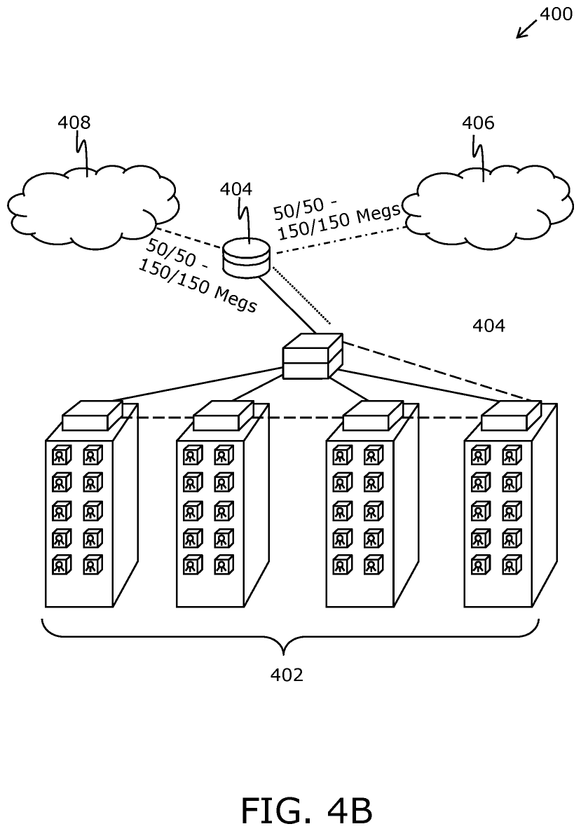

Referring to FIGS. 4A and 4B, there are shown schematic illustrations of a failover diagram 400 of the indoor vertical cultivation system 402, in accordance with various embodiments of the present disclosure. Moreover, the failover diagram 400 is created based on connectivity and the communication between the indoor vertical cultivation system 402 and the cloud-based server 404 in order to ensure effective internet connection. As shown in FIG. 4A, an Internet service providers (ISPs) 406 is used to ensure internet connectivity to the indoor vertical cultivation system 402. Moreover, the ISP 406 provides a download/upload speed of 50/50 Megs. As shown in FIG. 4B, at least two Internet service providers (ISPs), 406 and 408 may be used to ensure that if a first ISP 406 goes down, then a second ISP 408 may be used as a backup. Moreover, each of the first ISP 406 and the second ISP 408 provide a download/upload speed ranging from 50/50 to 150/150 Megs.

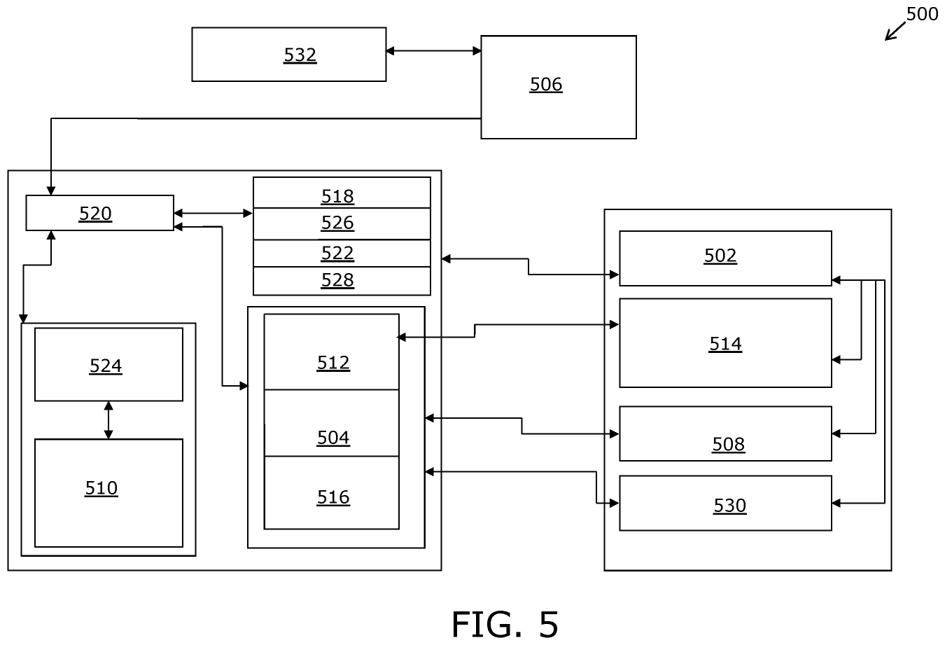

Referring to FIG. 5, is a block diagram showing an indoor vertical cultivation system 500 for cultivation of plants with various arrangements associated therewith, in accordance with an embodiment of the present disclosure. The indoor vertical cultivation system 500 for cultivation of plants comprises at least one cultivation rack 502 configured to house multiple habitats, wherein each of the multiple habitats is configured to grow the plants under optimal growth conditions unique to the plant therein. The indoor vertical cultivation system 500 for cultivation of plants comprises a harvesting arrangement configured to harvest the plant having an optimal growth; a power converter, associated with the indoor vertical cultivation system 500, that is able to adapt to local power voltage and frequency in order to provide electrical power for operating the indoor vertical cultivation system 500 used for measuring, controlling and monitoring the optimal growth conditions in each of the multiple habitats. Moreover, the system 500 comprises a dehumidification arrangement 504, associated with the indoor vertical cultivation system 500, for producing the water necessary for cultivation as well as used during the harvesting of the plant, wherein the plant is dried prior to harvest, and a software module 506, associated with the indoor vertical cultivation system 500, for measuring, controlling and monitoring growth conditions in each of the multiple habitats.

Furthermore, the software module 506 is configured to operate a water supply arrangement 508, a root chamber environment modulation arrangement 510, a light supply arrangement 512, an air conditioning arrangement 514 and an air sanitization arrangement 516, operatively coupled to each of the multiple habitats, to provide optimized deionized water with pH, electrical conductivity and optimal nutrients, optimal light intensity, and optimal air temperature, humidity and clean air, respectively, thereto. Additionally, the indoor vertical cultivation system 500 comprises a sensor arrangement 518 for measuring a set of growth conditions within each of the multiple habitats of the indoor vertical cultivation system 500; a controller arrangement 520 for controlling at least one growth condition from the set of growth conditions to achieve the optimal growth conditions in each of the multiple habitats for growing the plant. The indoor vertical cultivation system 500 comprises a camera arrangement 522 for monitoring the growth of the plant during the entire life cycle from a vegetative phase of the plant through a harvesting phase of the plant in each of the multiple habitats; a nutrient supply arrangement 524, operatively coupled to the water supply arrangement 508, for supplying nutrients with the water supply, wherein the nutrients are selected from a set of macronutrients and micronutrients.

Moreover, the indoor vertical cultivation system 500 comprises a temperature control arrangement 526, corresponding to each of the multiple habitats, for providing an optimal heating and cooling conditions for growing plants; a carbon dioxide arrangement 528, corresponding to each of the multiple habitats, for providing an optimal supply of carbon dioxide for growing plants. Furthermore, the indoor vertical cultivation system 500 comprises a power control arrangement 530, corresponding to each of the multiple habitats, for providing a power converter to each habitat by enabling the connection to different power voltage, phase, and frequency. The software module 506 is communicably coupled to cloud-based servers 532.

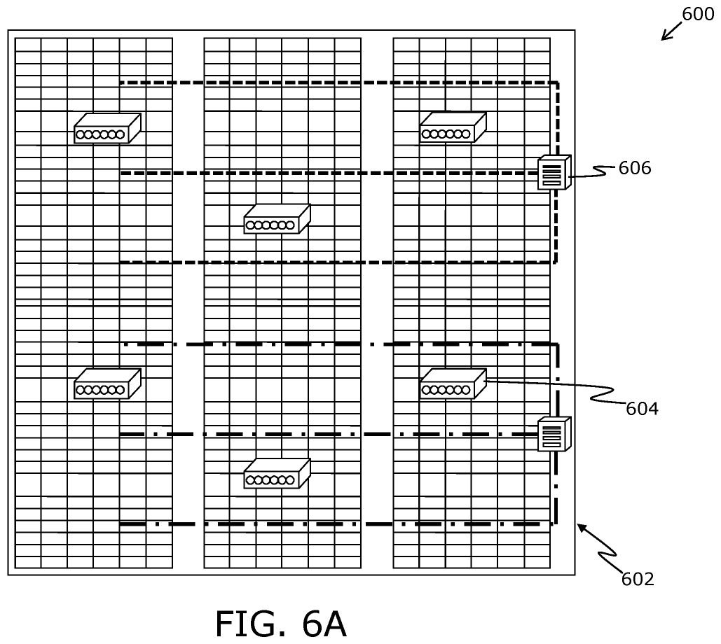

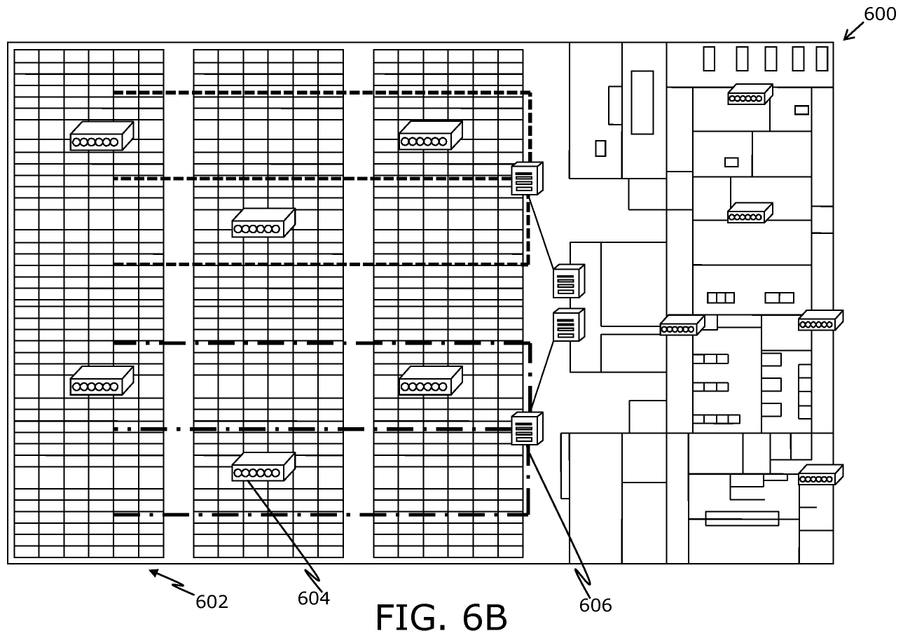

Referring to FIGS. 6A and 6B, there are shown schematic illustrations of exemplary implementation of network connectivity to the indoor vertical cultivation system, in accordance with various embodiments of the present disclosure. As shown in FIGS. 6A and 6B, the indoor vertical cultivation system 602 at least one secure cloud-based server 604, such as a Meraki MX68® cloud-based security appliance, and at least one port, including active ports, passive ports, access points, customer-premises equipment (CPE) 606, Uplinks (active and back-up), and so forth. Additionally, optionally, the indoor vertical cultivation system may comprise at least one ISP (not shown).

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. A method for automated indoor vertical cultivation of plants, the method comprising:
supplying seeds, plant cuttings, or plant tissue culture, to an indoor vertical cultivation system for cultivation of plants, the indoor vertical cultivation system comprising at least one cultivation rack configured to house multiple habitats, wherein each of the multiple habitats is configured to grow the plants under optimal growth conditions unique to the plant therein; and
operating a software module, associated with the indoor vertical cultivation system, for measuring, controlling and monitoring the optimal growth conditions in each of the multiple habitats that is capable of continual learning and improvement,
wherein the software module is configured to operate a water supply arrangement and an air sanitization arrangement, operatively coupled to each of the multiple habitats, to provide a water supply and clean air, respectively, thereto.

2. A method according to claim 1, wherein the at least one cultivation rack is a movable rack.

3. A method according to claim 1 or claim 2, wherein each of the multiple habitats are hermetically sealed chambers and are stacked on the at least one cultivation rack in at least one of: a vertical orientation, a horizontal orientation, a diagonal orientation, and a random orientation.

4. A method according to any one of claims 1 to 3, wherein the optimal growth conditions are selected from at least one of: temperature, humidity, air quality, light, nutrients, water circulation, water vapour size, pH, biological oxygen demand, total dissolved solids, carbon dioxide level, and electrical connectivity.

5. A method according to any one of claims 1 to 4, wherein the nutrients are selected from a set of macronutrients and micronutrients, and wherein the set of macronutrients and micronutrients are unique for a given plant.

6. A method according to claim 1, further comprising:
operating a dehumidification module of a dehumidification arrangement, associated with the indoor vertical cultivation system, for producing the water necessary for cultivation as well as used during the harvesting of the plant, wherein the plant is dried prior to harvest;
operating an electrical power converter module of a power converter, associated with the indoor vertical cultivation system, that is able to adapt to local power voltage and frequency in order to provide electrical power for operating the indoor vertical cultivation system used for measuring, controlling and monitoring the optimal growth conditions in each of the multiple habitats, and wherein the multiple habitats are configured in a way that provides a power converter to each habitat by enabling the connection to different power voltage, phase, and frequency; and
operating a harvesting arrangement, associated with the indoor vertical cultivation system, for harvesting the plant having an optimal growth.

7. A method according to claim 6, wherein the water supply arrangement is operatively coupled to the dehumidification system, wherein the dehumidification system collects moisture from the air, stores and delivers the captured clean deionized water, via the water supply arrangement, to each of the multiple habitats.

8. A method according to claim 1, wherein the software module is further configured for operating:
a root chamber environment modulation arrangement, operatively coupled to each of the multiple habitats, to provide optimized water with pH, electrical conductivity and optimal nutrients thereto;
a light supply arrangement, operatively coupled to each of the multiple habitats, to provide an optimal light intensity thereto; and
an air conditioning arrangement, operatively coupled to each of the multiple habitats, to provide an optimal air temperature and humidity thereto.

9. A method according to any one of claims 1 to 8, and wherein the software module is configured to obtain, from a database, and use a data associated with the plant in each of the multiple habitats, wherein the data corresponds to at least one of: a name, a growth condition, a unique tag number, and a harvesting schedule of the plant, and wherein each of the multiple habitats are on a different harvest schedule.

10. A method according to any one of claims 1 to 9, wherein the software module is further configured for
measuring, by using a sensor arrangement, a set of growth conditions within each of the multiple habitats of the indoor vertical cultivation system;
controlling, by using a controller arrangement, at least one growth condition from the set of growth conditions to achieve the optimal growth conditions in each of the multiple habitats for growing the plant; and
monitoring, by using a camera arrangement, the growth of the plant during the entire life cycle from a vegetative phase of the plant through a harvesting phase of the plant in each of the multiple habitats.

11. A method according to any one of claims 6 and 7, wherein the software module is further configured for operating the controller arrangement for communicating with
the water supply arrangement, for supplying the water supply;
the dehumidification system, operatively coupled to the water supply arrangement, for supplying a clean deionized water, via the water supply arrangement, to each of the multiple habitats;
a nutrient supply arrangement, operatively coupled to the water supply arrangement, for supplying optimal nutrients with the water supply;
the air conditioning arrangement, corresponding to each of the multiple habitats, for providing an optimal heating and cooling conditions for growing plants;
the light supply arrangement, corresponding to each of the multiple habitats, for providing an optimal light for growing plants;
a carbon dioxide arrangement, corresponding to each of the multiple habitats, for providing an optimal supply of carbon dioxide for growing plants; and
a power source arrangement, corresponding to each of the multiple habitats, for providing a power converter to each habitat by enabling the connection to different power voltage, phase, and frequency.

12. A method according to any one of claims 1 to 11, wherein the sensor arrangement comprises at least one of: a gas concentration sensor, a temperature sensor, a humidity sensor, a total dissolved solids sensor, a water particle size sensor, a water temperature sensor, a pH senor, an electrical conductivity sensor, a light sensor and a plant colour sensor.

13. A method according to any one of claims 1 to 12, wherein the air sanitization arrangement employs a series of filters and an ultraviolet germicidal irradiation designed to trap and destroy virus, bacteria, mold, pest and other contaminants to a 99.99% success ratio.

14. A method according to claim 13, wherein the ultraviolet germicidal irradiation is generated from at least one of: a UV bulb and a biocidal film reflective panel.

15. A method according to any one of claims 1 to 14, wherein the software module comprises standard operating procedures and process flows associated with the plants.

16. A method according to any one of claims 1 to 15, wherein the software module is trained using artificial intelligence tools.

17. A method according to any one of claims 1 to 16, wherein the software module provides a secure communication between the indoor vertical cultivation system and associated components therewith, and wherein providing secure communication comprises receiving access authorization information from a secure cloud-based server, and allowing access to the software module only for software components identified by the access authorization information.

18. An indoor vertical cultivation system for cultivation of plants, the indoor vertical cultivation system comprising:
at least one cultivation rack configured to house multiple habitats, wherein each of the multiple habitats is configured to grow the plants, from a supply of seeds, plant cuttings, or plant tissue culture, under optimal growth conditions unique to the plant therein; ; and
a software module, associated with the indoor vertical cultivation system, for measuring, controlling and monitoring the optimal growth conditions in each of the multiple habitats that is capable of continual learning and improvement,
wherein the software module is configured to operate a water supply arrangement and an air sanitization arrangement, operatively coupled to each of the multiple habitats, to provide a water supply and clean air, respectively, thereto.

19. An indoor vertical cultivation system according to claim 18, wherein the at least one cultivation rack is a movable rack.

20. An indoor vertical cultivation system according to claim 18 or claim 19, wherein each of the multiple habitats are hermetically sealed chambers and are stacked on the at least one cultivation rack in at least one of: a vertical orientation, a horizontal orientation, a diagonal orientation, and a random orientation.

21. An indoor vertical cultivation system according to claim 18 to claim 20, further comprising
a sensor arrangement for measuring a set of growth conditions within each of the multiple habitats of the indoor vertical cultivation system;
a controller arrangement for controlling at least one growth condition from the set of growth conditions to achieve the optimal growth conditions in each of the multiple habitats for growing the plant;
a camera arrangement for monitoring the growth of the plant during the entire life cycle from a vegetative phase of the plant through a harvesting phase of the plant in each of the multiple habitats;
the water supply arrangement, for supplying the water supply;
a dehumidification system, operatively coupled to the water supply arrangement, for supplying clean deionized water, via the water supply arrangement, to each of the multiple habitats, wherein the dehumidification system collects moisture from the air, stores and delivers the captured clean deionized water to be supplied with the water supply necessary for cultivation as well as used during the harvesting of the plant, wherein the plant is dried prior to harvest;
a nutrient supply arrangement, operatively coupled to the water supply arrangement, for supplying nutrients with the water supply, wherein the nutrients are selected from a set of macronutrients and micronutrients;
a root chamber environment modulation arrangement, operatively coupled to each of the multiple habitats, to provide optimized water with pH, electrical conductivity and optimal nutrients thereto;
an air conditioning arrangement, corresponding to each of the multiple habitats, for providing an optimal heating and cooling conditions for growing plants; and
a light supply arrangement, corresponding to each of the multiple habitats, for providing an optimal light for growing plants a carbon dioxide arrangement, corresponding to each of the multiple habitats, for providing an optimal supply of carbon dioxide for growing plants;
a power source arrangement, corresponding to each of the multiple habitats, for providing a power converter to each habitat by enabling the connection to different power voltage, phase, and frequency, wherein an electrical power converter module of the power converter, that is able to adapt to local power voltage and frequency, provides electrical power for operating the indoor vertical cultivation system used for measuring, controlling and monitoring the optimal growth conditions in each of the multiple habitats, and wherein the multiple habitats are configured in a way that provides a power converter to each habitat by enabling the connection to different power voltage, phase, and frequency;
a database for providing the software module a data associated with the plant in each of the multiple habitats, wherein the data corresponds to at least one of: a name, a growth condition, a unique tag number, and a harvesting schedule of the plant, and wherein each of the multiple habitats are on a different harvest schedule; and
a harvesting arrangement, associated with the indoor vertical cultivation system, for harvesting the plant having an optimal growth.

22. An indoor vertical cultivation system according to claim 21, wherein the sensor arrangement comprises at least one of: a gas concentration sensor, a temperature sensor, a humidity sensor, a total dissolved solids sensor, a water particle size sensor, a water temperature sensor, a pH senor, an electrical conductivity sensor, a light sensor and a plant colour sensor.

23. An indoor vertical cultivation system according to any one of claims 18 to 22, wherein the air sanitization arrangement employs a series of filters and at least one of: a UV bulb and a biocidal film reflective panel to generate an ultraviolet germicidal irradiation designed to trap and destroy virus, bacteria, mold, pest and other contaminants to a 99.99% success ratio.

24. A computer program product comprising a non-transitory computer-readable storage medium having computer-readable instructions stored thereon, the computer-readable instructions being executable by a computerized device comprising processing hardware to execute a method of any one of claims 1 to 17.

25. A computer program product that employs artificial intelligence to continually optimize the method of any one of claims 1 to 17 to reduce water, power and cycle time while increasing yield weight, improving crispness, flavour and/or shelf life through the measurement, collection, management, analysis, and correlation of the data collected during the run of previous methods.
